(19) United States
(12) Patent Application Publication
(10) Pub. No.: US 2002/0002531 A1
(43) Pub. Date: Jan. 3, 2002

(54) System and method for facilitating a transaction through binding comparison shopping using a communications network

(76) Inventors: Andrew Lustig, Old Tappan, NJ (US); Jeffrey Isaac, Norwood, NJ (US); Mark Bernard, New Paltz, NY (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/866,979

(22) Filed: May 29, 2001

Related U.S. Application Data
(60) Provisional application No. 60/208,023, filed on May 30, 2000.
(60) Provisional application No. 60/208,747, filed on Jun. 2, 2000.

(51) Int. Cl. G06F 17/60

(52) U.S. Cl. 705/37

(57) ABSTRACT

A method for facilitating a transaction that includes receiving information describing an offer presented to a user; receiving an indication that the user desires to accept the offer unless a better offer is available, and accept the better offer when the better offer is available; providing the offer information for delivery to a system having access to information describing the other available offers, being adapted to compare the offer information with the other available offer information to determine whether the better offer is available, being adapted to provide information related to the determination, and being adapted to accept the better offer on behalf of the user when the better offer is available; and receiving the determination information and providing the determination information for delivery to an interested party, the determination information comprising an indication that the better offer has been accepted by the system.

### CROSS-REFERENCE TO RELATED APPLICATIONS

The present application claims the benefit of United States Provisional Application Ser. No. 60/208,023, filed May 30, 2000, and United States Provisional Application Ser. No. 60/208,747, filed Jun. 2, 2000 the disclosures of which are hereby fully incorporated by reference herein.

### BACKGROUND OF THE INVENTION

Electronic trading systems and electronic commerce systems have become increasingly popular and useful with the advent of the Internet and similar communications networks. This is in part due to the standardization of communication protocols, increased transmission speeds, and the availability of large amounts of information. Still, these advances have not changed certain problematic aspects of exchanges generally and the buying and selling of products.

Regardless of the particular type of market, each buyer and seller is seeking the best deal he or she can find. In theory, perfectly efficient markets require full disclosure of supply and demand, i.e., buyers and sellers must know the price at which every possible deal can be done before they can make perfect decisions. In practice, however, there are substantial barriers to full disclosure. For example, car dealers will not publish their true bottom-line prices, homebuyers will rarely begin negotiations with their highest bid, and institutional equities traders will go to great lengths to avoid revealing to the market their full price and quantity parameters. Without full disclosure, buyers and sellers must make decisions “in the dark”, never knowing if they have found or negotiated the best possible deal. The market process can therefore be slow, aggravating, and inefficient, providing participants with a strong incentive to seek, negotiate, and close deals away from the exchange.

Given the practical barriers to full disclosure, a buyer or seller is typically unable to determine whether the current offer he or she is considering is optimal. More specifically, he or she is unable to obtain information on other similar offers, especially a large number of similar offers with which to compare offer parameters to determine the best deal.

Time spent comparing offers is especially critical in business-to-business markets, because the wasted time can be put to good business use in other endeavors. In most cases, a business has determined that a particular product must be bought or sold, and are simply attempting to strike the best deal. The business is willing to commit to purchasing or selling the product, but wants to ensure that the best deal is stuck in the shortest amount of time. With currently available systems, not only is time spent locating and/or negotiating the best deal, but time is also spent processing the transaction once a buying or selling commitment has been made.

In most cases, a person or business representative cannot afford to spend time comparison shopping, even with the above-mentioned services, but would rather simply visit a vendor's Web site, locate a desired product, and commit to purchasing it. However, he or she also cannot afford to enter into a less-than-optimal transaction. Unfortunately, while the vendor's Web site provides the option to buy the product at the listed price, it does not provide the option to make sure that is the best deal possible. The lack of such an option makes a prospective buyer unsure of whether the deal is best, and therefore distrustful of the vendor. If the deal is not the best, the purchaser will likely discover this after it is too late to void the transaction, and will also likely avoid the vendor the next time.

Therefore, there is a need for a system and method that enables a prospective buyer or seller to reduce the time spent shopping for the best offer. There is also a need for a system and method that reduces the difficulty associated with determining whether a better offer exists. There is a further need for a system and method that reduces the time spent to close a transaction after determining whether a better offer exists. There is also a need for a system and method that enhances the confidence of the prospective buyer or seller with regard to the contemplated transaction.

### SUMMARY OF THE INVENTION

In an embodiment, the invention includes a method for facilitating a transaction, including receiving information describing an offer presented to a user; and receiving an indication that the user desires to accept the offer unless a better offer is available, and accept the better offer when the better offer is available, the better offer being similar with regard to at least one parameter, and more optimal with regard to at least one other parameter, than the offer and other available offers.

Preferably, the invention in this embodiment further includes providing the offer information for delivery to a system having access to information describing the other available offers, being adapted to compare the offer information with the available offer information to determine whether the better offer is available, being adapted to provide information related to the determination, and being adapted to accept the better offer on behalf of the user when the better offer is available; and receiving the determination information and providing the determination information for delivery to an interested party. When the better offer is not available, the determination information includes an indication that the better offer is not available. When the better offer is available, the determination information includes at least one of an indication that the better offer is available, a description of the better offer, and an indication that the better offer has been accepted by the system.

Also preferably in this embodiment, the system is further adapted to accept the offer on behalf of the user unless the better offer is available. When the better offer is not available, the determination information further includes an indication that the offer has been accepted by the system.

In one aspect, the one parameter is a product identity and the other parameter is a consideration amount to be paid in exchange for the product.

In another aspect, the interested party is selected from the group consisting of the user, an offeror of the offer, and an offeror of the better offer.

In yet another aspect, receiving the offer information and receiving the indication are as a result of a singular action by the user. Preferably, the action is selected from the group consisting of clicking a button, generating a sound, pressing a keyboard key, selecting using a remote control, selecting using a pointing device, and selecting a Web page object.

In another embodiment, the invention provides a method for facilitating a transaction, including publishing information describing an offer for presentation to a user; and providing an option for the user to accept the offer unless the better offer is available, and to accept the better offer when the better offer is available, the better offer being similar with regard to at least one parameter, and more optimal with regard to at least one other parameter, than the offer and other available offers.

Preferably, the invention in this embodiment further includes receiving an indication that the user desires to exercise the option; and providing the offer information for delivery to a system having access to information describing the other available offers, being adapted to compare the offer information with the available offer information to determine whether the better offer is available, being adapted to provide information related to the determination, and being adapted to accept the better offer on behalf of the user when the better offer is available.

In one aspect, the offer information is provided to the system through an intermediary.

In another aspect, the system is further adapted to accept the offer on behalf of the user unless the better offer is available.

Also preferably, the invention in this embodiment further includes receiving the determination information. When the better offer is available, the determination information includes an indication that the better offer is available. When the better offer is not available, the determination information includes an indication that the better offer is not available. Preferably, the determination information is received through an intermediary.

Also preferably, the invention in this embodiment further includes, when the better offer is not available, accepting the offer on behalf of the user. Also preferably, the invention in this embodiment further includes, when the better offer is not available, providing for delivery to the user an indication that the better offer is not available.

In one aspect, publishing the offer information for presentation to the user includes publishing information describing a plurality of offers, the offer being one of said plurality of offers.

In still another aspect, the offer is offered using a Web page.

In still another aspect, the indication that the user desires to exercise the option is provided by the user performing an action selected from the group consisting of clicking a button, generating a sound, pressing a keyboard key, selecting using a remote control, selecting using a pointing device, and selecting a Web page object.

In still another aspect, the option is made available via a Web page and can be exercised by selecting a portion of the Web page. Preferably, the portion of the Web page displays a graphic button.

In yet another embodiment, the invention provides a system including at least one microprocessor operating under the control of at least one software program capable of causing the system to execute actions in facilitating a transaction, the actions including receiving information describing an offer presented to a user; and receiving an indication that the user desires to accept the offer unless a better offer is available, and accept the better offer when the better offer is available, the better offer being similar with regard to at least one parameter, and more optimal with regard to at least one other parameter, than the offer and other available offers.

Preferably, in this embodiment, the actions further include providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available; and receiving the determination information and providing the determination information for delivery to an interested party. When the better offer is not available, the determination information includes an indication that the better offer is not available. When the better offer is available, the determination information includes at least one of an indication that the better offer is available, a description of the better offer, and an indication that the better offer has been accepted by the determining system.

In still another embodiment, the invention provides a system including a microprocessor operating under the control of at least one software program capable of causing the system to execute actions in facilitating a transaction, the actions including publishing information describing an offer for presentation to a user; and providing an option for the user to accept the offer unless the better offer is available, and to accept the better offer when the better offer is available, the better offer being similar with regard to at least one parameter, and more optimal with regard to at least one other parameter, than the offer and other available offers.

Preferably, in this embodiment, the actions further include receiving an indication that the user desires to exercise the option; and providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available.

In still another embodiment, the invention provides a system capable of facilitating a transaction, including means for receiving information describing an offer presented to a user; and means for receiving an indication that the user desires to accept the offer unless a better offer is available, and accept the better offer when the better offer is available, the better offer being similar with regard to at least one parameter, and more optimal with regard to at least one other parameter, than the offer and other available offers.

Preferably, in this embodiment, the system further includes means for providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available; and means for receiving the determination information and providing the determination information for delivery to an interested party. When the better offer is not available, the determination information includes an indication that the better offer is not available. When the better offer is available, the determination information includes an indication that the better offer is available, a description of the better offer, and an indication that the better offer has been accepted by the determining system.

In still another embodiment, the invention provides a system capable of facilitating a transaction, including means for publishing information describing an offer for presentation to a user; and means for providing an option for the user to accept the offer unless the better offer is available, and to accept the better offer when the better offer is available, the better offer being similar with regard to at least one parameter, and more optimal with regard to at least one other parameter, than the offer and other available offers.

Preferably, in this embodiment, the system further includes means for receiving an indication that the user desires to exercise the option; and means for providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available.

### BRIEF DESCRIPTION OF THE DRAWINGS

FIG. 1 is a schematic diagram of an embodiment of a system of the invention.

FIG. 2 is a schematic diagram of a Publisher Server of the embodiment of FIG. 1.

FIG. 3 is a schematic diagram of an Order Server of the embodiment of FIG. 1.

### DETAILED DESCRIPTION

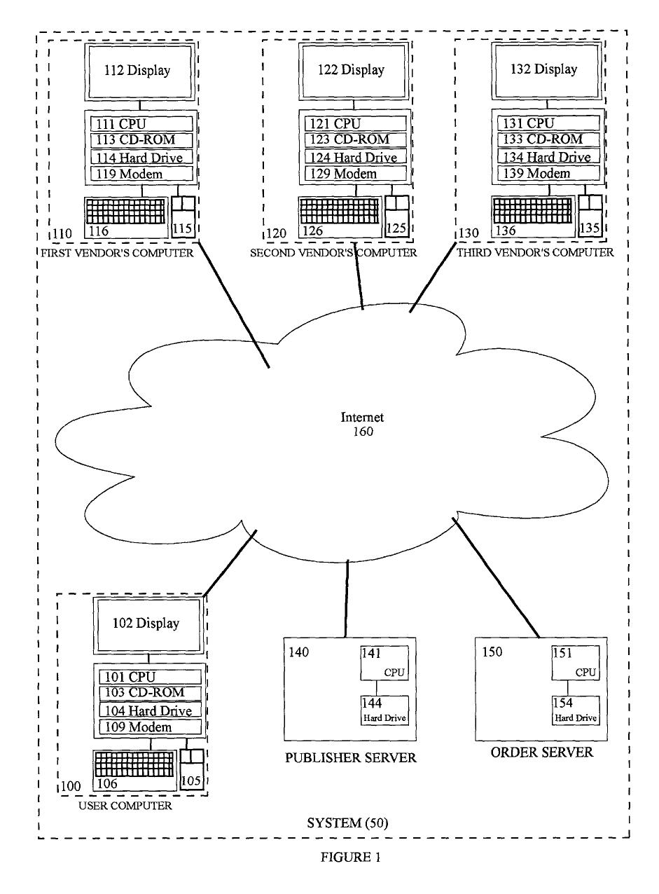

Referring now to FIG. 1, a system 50 in accordance with an embodiment of the invention includes a network of computers that includes an end user computer 100, a plurality of product vendor computers 110,120,130 and a plurality of Web servers 140,150 all communicating with one another via an Internet 160. Although only a few computers are depicted in FIG. 1, it should be appreciated that a typical system can include a large number of connected computers.

Each of the computers 100,110,120,130 and Web servers 140,150 may be any device capable of processing instructions and transmitting information to and from humans and other computers, including network computers lacking local storage capability, personal digital assistants (PDAs) with modems, and Internet-capable wireless phones.

Preferably, each of the computers 100,110,120,130 is a general purpose computer having components normally found in a computer such as, for example, a central processing unit (CPU) 101,111,121,131, a display 102,112,122,132, a CD-ROM drive 103,113,123,133, a hard drive 104,114,124,134, a mouse 105,115,125,135, a keyboard 106,116,126,136, a modem 109,119,129,139 and all of the components used for connecting these elements to one another. For example, one or more of the computers 100,110,120,130 can be an IBM™ PC-compatible computer running a Microsoft™ Windows™ operating system and Microsoft™ Internet Explorer™ or Netscape™ Navigator™. Or, for example, one or more of the computers 100,110,120,130 can be an IBM™ PC-compatible computer running a Linux™ operating system and Netscape™ Navigator™ or Mozilla™. Or, for example, one or more of the computers 100,110,120,130 can be a Sun Microsystems™ computer running a Unix™ or Solaris™ operating system and Netscape™ Navigator™. Each computer 100,110,120,120 can communicate with the Internet 160 via its modem 109,119,129,139. It should be appreciated that although the CPUs 101,111,121,131 are shown as single processors, the instructions may be distributed to a number of different components or processors for execution. Further, other means for inputting information from a human into a computer, in addition to those shown, are also acceptable such as, for example, a touch sensitive screen and a voice recognition system.

In this embodiment, the user computer 100 is operated by an end user and each of the vendor computers 110,120,130 is operated by a respective product vendor. Each end user and product vendor can be an individual, a company representative, a computer agent, and/or any other person or entity that functions to buy and/or sell products for himself or herself or on behalf of someone else or on behalf of a company or other entity such as, for example, in some embodiments, a product vendor. Each end user and product vendor can be a “trader” as that term is defined and discussed in U.S. patent application Ser. No. 09/413,033, filed Oct. 6, 1999 (the “'033 application”), the disclosure of which is hereby fully incorporated herein by reference.

In this embodiment, for simplicity of explanation, the end user will be referred to herein as the “User” and the user computer 100 will be referred to herein as the “User's computer”. Similarly, the vendors will be referred to herein as the “First Vendor”, “Second Vendor” and “Third Vendor”, respectively, and the computers 110,120,130 will be referred to herein as the First Vendor's computer 110, the Second Vendor's computer 120, and the Third Vendor's computer 130. The term “product” when used herein shall include goods, services and/or any item or experience that can be obtained in exchange for consideration. The term “product” when used herein can include fungible items, nearly fungible items, and/or unique items, as discussed in the '033 application. For example, an end user and/or a product vendor may buy and/or sell merchandise, entertainment packages, commodities, equities and/or services.

Each of the Web servers 140,150 can be a typical Web server, computer network server and/or other automated system capable of communicating with other computers over a network, including the Internet 160, Wide Area Networks (WANs) or Local Area Networks (LANs). Each of the Web servers 140,150 includes hardware and software for sending and receiving information in that regard. The information can be in the form of data, instructions, Web pages, requests, and/or files. The hardware includes components normally found in a Web server such as, for example, one or more CPUs 141,151 and one or more hard drives 144,154. For example, one or more of the Web Servers 140,150 can be an IBM™ PC-compatible computer running a Microsoft™ Windows NT™ or Windows 2000™ operating system. Or, for example, one or more of the Web Servers 140,150 can be an IBM™ PC-compatible computer running a Linux™ operating system. Or, for example, one or more of the Web Servers 140,150 can be a Sun Microsystems™ computer running a Unix™ or Solaris™ operating system. Each of the Web servers 140,150 can communicate with the Internet 160 via communication hubs, routers and other communication hardware known in the art.

Each of the computers 100,110,120,130 and the Web servers 140,150 includes instructions and a variety of information. Preferably, the instructions and information are stored on the respective hard drive 104,114,124,134,144,154 of the computer 100,110,120,130 or Web server 140,150. Certain functions, methods and routines of the instructions and information are explained below.

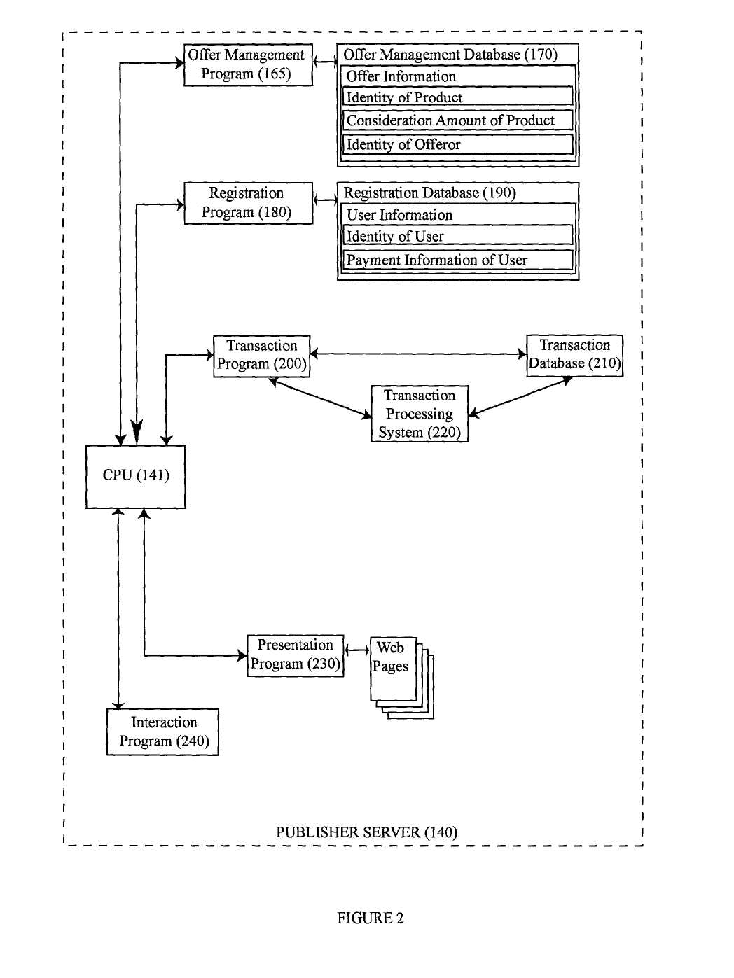

Referring now also to FIG. 2, in this embodiment, the Web server 140 is operated by a company that publishes offers from one or more vendors. Therefore, for simplicity of explanation, the company will be referred to as the “Publisher”, and the Web server 140 will be referred to as the “Publisher Server”. Each vendor desiring to have an offer published by the Publisher (e.g., the First and Second Vendors in the following examples), provides to the Publisher (e.g., using the vendor's respective vendor computer) information describing the offer. Each offer is either an offer to buy a particular product or an offer to sell a particular product. An offer to sell a particular product can be an “ask” as that term is defined and discussed in the '033 application. An offer to buy a particular product can be a “bid” as that term is defined and discussed in the '033 application. Preferably, each offer is a “Now or Never Order” as that term is defined and discussed in the '033 application.

Each offer has at least two parameters, and at least one of those parameters identifies the product. The other parameter is some value associated with the product, such as, for example, a consideration amount (e.g., a price), a quality, a delivery time, a delivery location, an attribute of the product (e.g., color, size and/or a feature), included accessories, warranty terms and/or conditions, an identity and/or reputation of the vendor, and/or an identity and/or reputation of the manufacturer. It should be understood that the original offer can have additional or alternate parameters, depending on the nature of the proposed transaction, and the importance of the various parameters to the transaction.

After receiving the offer information from each vendor, the Publisher, on behalf of the vendor, uses the Web server 140 to present Web pages that contain the offer information, for example, in the manner of an electronic catalog. Accordingly, the User can operate the computer 100 to navigate the Web pages to view information about desired products by browsing through hyperlinks on the Web pages and/or performing keyword searches using search engines provided by the Web site. The Publisher Server 140 in some embodiments can function as an “exchange”, as that term is defined and discussed in the '033 application. Further in some embodiments, the Publisher can be a vendor and/or the Publisher Server can be owned and/or operated by one more vendors. In some of such embodiments, the functionalities of a vendor computer and the Publisher Server may be achieved using one server or computer.

In the following examples, the Publisher has obtained from the First Vendor's computer 110 offer information describing an offer (referred to herein as the “First Offer”) to sell a product (referred to herein as the “Item”) at a first price (referred to herein as the “First Price”), and has obtained from the Second Vendor's computer 120 information describing an offer (referred to herein as the “Second Offer”) to sell an equivalent Item at a second price (referred to herein as the “Second Price”).

Each offer published on the Publisher's Web site has associated therewith the offer information discussed above. Accordingly, the Publisher Server 140 includes an offer management program 165 that in coordination with an offer management database 170 organizes, stores, and retrieves the offer information. The offer information for each offer preferably includes the parameters of the offer. In this embodiment, the offer information includes the identity of the offeror (e.g., the particular vendor), the identity of the product, and a consideration amount to be paid in exchange for the product. The identity of the product can include the “Item ID” as that term is defined and discussed in the '033 application. Typically, the consideration amount will be a price represented in terms of a commonly used monetary unit such as, for example, United States dollars. The consideration could also take other forms, such as, for example, award points or credit. It should be understood that in other embodiments, the offer information can include additional and/or alternate information, including one or more of the various offer parameters identified above. The offer information can include one or more of the “Order Entry Settings” and/or “delivery terms” as those terms are defined and discussed in the '033 application.

Each user desiring to accept an offer published by the Publisher has associated therewith user information. Accordingly, the Publisher Server 140 includes a registration program 180 that in coordination with a registration database 190 organizes, stores and retrieves the user information. The user information for each user includes an identity of the user and payment information of the user. Typically, the user information includes the name of the user and a credit account number of the user. Other examples of suitable payment information include an account number for a debit account of the user and an authorization code that can be used to debit the account. Other examples of suitable payment information include the user's credit card type, number and expiration date. The payment information of the user can include information necessary to enable the use of a “payment method”, as that term is defined and discussed in the '033 application. The user information may be collected by the registration program 180 and database 190 in any suitable manner, but is preferably collected as part of a user registration process in which each user is required to provide the user information before being presented with offers. It should be noted that in other embodiments, the user information can include additional and/or alternate information, and the registration process can take place at different times and with different requirements. For example, the user information can include the “Global Level Settings”, “Exchange Level Settings”, “Account Level Settings” and “Order Level Settings” as those terms are defined and discussed in the '033 application.

The Publisher Server 140 enables users to purchase and/or sell products using the Web site. Accordingly, the Publisher Server 140 includes a transaction program 200 that in coordination with a transaction database 210 and transaction processing system 220 can be used to close financial transactions between users and vendors (or between users and the Publisher if, as is the case in some embodiments, the Publisher is a vendor and/or is acting as an agent of one or more of the vendors). The transaction program 200, database 210, and processing system 220 include common components for processing orders over the Internet 160. For example, the processing system 220 can include personnel and communication, packaging, and delivery systems that can interact with the transaction program 200 and database 210 to achieve this functionality. It should be understood that additional and/or alternate components can be included in other embodiments and/or can be tailored to account for specific requirements of a given market.

The Publisher Server 140 presents information and options to the users primarily through a Web page interface. Accordingly, the Publisher Server 140 includes a presentation program 230 that dynamically selects and/or constructs a plurality of Web pages for presentation. The Web pages and/or the components of the Web pages are stored on the hard drive 144 of the Publisher Server 140 and can be used to present, among other information, the offer information.

The Publisher Server 140 is adapted to receive input from and provide information to the computers and other Web servers. The Publisher Server 140 further includes an interaction program 240 that interacts with the computers and other Web servers using hypertext transfer protocol (HTTP), transmission control protocol/Internet protocol (TCP/IP) and other Internet communication protocols. The interaction with users is primarily through a Web page interface. The interaction with the other computers and the other Web servers may also involve the transfer of Web pages, but may only involve the transmission and receipt of instructions, requests and information. The interaction program 240 also interacts with the other programs 165, 180, 200, 230 to coordinate the functions of the programs in response to requests and submissions from other computers, particularly the user and vendor computers 100,110,120,130 and the Web server 150, as discussed below.

For example, as the Publisher Server 140 allows users to navigate or search through the Publisher's electronic catalog to locate offers, the interaction program 240 operates in coordination with the offer management program 165 to retrieve the offer information associated with the offers, and thereafter in coordination with the presentation program 230 to present Web pages containing the offer information.

Further, for example, as the Publisher Server 140 allows users to accept offers, the interaction program 240 operates in coordination with the offer management program 165 to retrieve the offer information associated with the offers, in coordination with the registration program 180 to collect and retrieve the user information, in coordination with the transaction program 200 to effect the transaction using the offer information and user information, and in coordination with the presentation program 230 to present Web pages throughout these processes to facilitate communication between the user computer 110 and the other programs.

All of the programs 165, 180, 200, 230, 240 can, as required, instruct one another, make requests of one another, and share information. This functionality and the functionality of each of the programs individually are directed by the CPU 141 of the Publisher Server 140. The information described herein in relation to the described functionality is stored as required on the hard drive 144 of the Publisher Server 140. Communications with the computers 100,110,120,130, Order Server 150, and other nodes of the Internet 160, including nodes owned and operated by third parties, are accomplished using the communication hardware of the Publisher Server 140. This functionality, storage and communication will be described below with regard to the operation of the system 50.

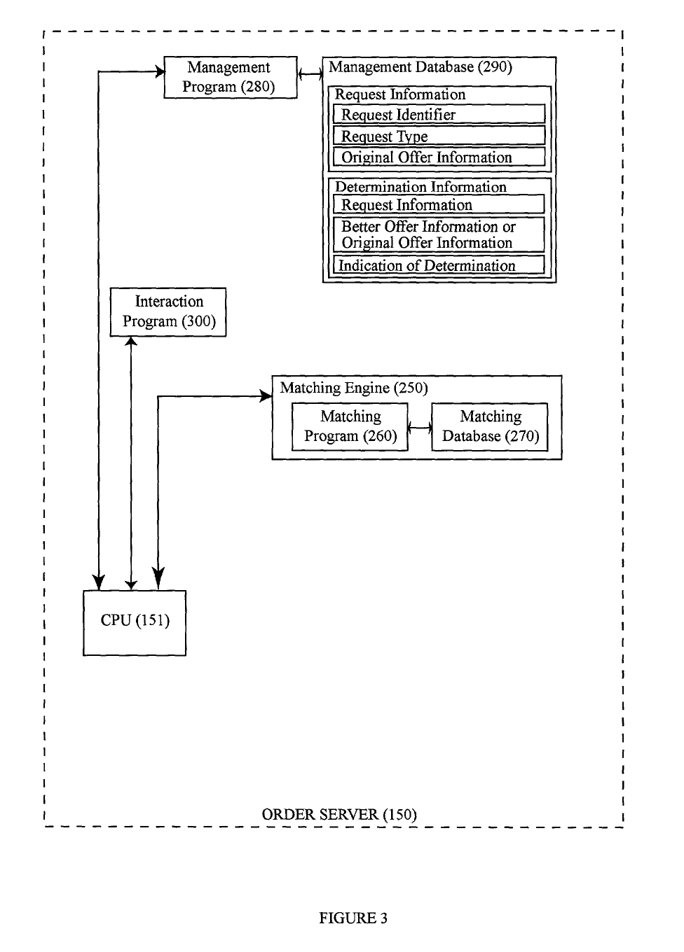

Referring now also to FIG. 3, in this embodiment, the Web server 150 is operated by a facilitator of transactions between companies such as, for example, the First, Second and Third Vendors, and users, such as, for example, the User. For simplicity of explanation, the facilitator will be referred to as the “Facilitator”, and the Web server 150 will be referred to as the “Order Server”, inasmuch as the Facilitator uses the Web server 150 to exchange requests and information with the computers 100,110,120,130, the Publisher Server 140, and/or other computers and/or Web servers, as part of a facilitation process described below. In some embodiments, the Order Server 150 and the Publisher Server 140 can be owned and/or operated by the same person or entity. In some of such embodiments, the functionalities of the Order Server 150 and the Publisher Server 140 can be achieved using one server or computer.

To facilitate transactions, the Order Server 150 has access to a system 250 that is adapted to determine the best offer among an original offer and other available offers. The scope of these terms will be provided by the discussion below. For simplicity of explanation, the system 250 will be referred to herein as the “Matching Engine”. The Matching Engine 250 can include the “electronic trading system” that is defined and discussed in the '033 application and which is referred to at times therein as the “Eureka Trading System” or “ETS”. In this embodiment, the Matching Engine 250 is a component of the Order Server 150. It should be understood that the Matching Engine 250 can in other embodiments be part of another computer connected to the network, and/or be operated by the Facilitator and/or another entity.

The Matching Engine 250 includes a matching program 260 that in coordination with a matching database 270 organizes, stores, and retrieves information that describes a plurality of available offers made by one or more product vendors to buy and/or sell products. The matching database 270 can be the “Order Book” as that term is defined and discussed in the '033 application. Preferably, the available offer information describes the parameters of the available offers and is stored in the matching database 270. In this embodiment, the available offer information includes, for each available offer, offer information for the available offer (e.g., the identity of the offeror, the identity of the product, and a consideration amount to be paid in exchange for the product. Any suitable system and/or method can be used to input the available offer information into the matching database 270. In this embodiment, the First, Second and Third Vendors can use the vendor computers 110,120,130 in communication with the Order Server 150 to provide the available offer information to the matching program 260 that then stores the available offer information in the matching database 270.

Preferably, the available offer information is continuously updated in real time to accurately reflect the most current information. This can be accomplished by allowing the product vendors to provide the available offer information to the matching program 260, directly or by way of an intermediary such as, for example, the Order Server 150, as soon as they desire to change any parameter of the offers they have provided. This is particularly advantageous with regard to markets such as, for example, financial or collectibles markets, in which the parameters of the offers include time-sensitive information.

Each of the available offers may or may not be published. A published offer would be an offer that is in the matching database 270 and also available for viewing and acceptance elsewhere (e.g., on the Publisher Server 140). A published offer can be a “displayed order” as that term is defined and discussed in the '033 application. A non-published offer would be an offer that is in the matching database 270, but which has not been made available for viewing or acceptance elsewhere (e.g., on the Publisher Server 140). An unpublished offer can be a “hidden order” as that term is defined and discussed in the '033 application. Each of the available offers can be a “standing order” as that term is defined and discussed in the '033 application.

In the following examples, the Second offer information has previously been received from the Second Vendor's computer 144 by the matching program 260 and stored in the matching database 270. Because the Second Offer information is available via the Publisher Server 140 and is also in the matching database 270, the Second Offer is considered a published offer. Further in the following examples, information describing an offer (referred to herein as the “Third Offer”) to sell an equivalent Item at a third price (referred to herein as the “Third Price”) has previously been received from the Third Vendor's computer 130 by the matching program 260 and stored in the matching database 270. Because the Third Offer information is not available via the Publisher Server 140 but is in the matching database 270, the Third Offer is considered an unpublished offer.

The matching program 260 is adapted to, upon request, and upon receipt of the original offer information, retrieve the available offer information from the matching database 270 and compare the available offer information with the original offer information to determine whether the better offer is available.

Further, the matching program 260 is adapted to, when directed, accept the better offer on behalf of the user originating the request. In this embodiment, the matching program 260 is also adapted to, when directed, accept the original offer on behalf of the user originating the request, if the original offer information is in the matching database 270.

The preferred structure of the Matching Engine 250 and the preferred manner in which the Matching Engine 250 performs the functions described herein are described in greater detail in the '033 application.

Further to facilitate transactions, the Order Server 150 includes a management program 280 that in coordination with a management database 290 organizes, stores, and retrieves information related to the requests that are exchanged with the User's computer 100 and the Publisher Server 140. In addition, the management program 280 in coordination with the management database 290 organizes, stores, and retrieves information related to the determinations made by the Matching Engine 250. The request information is used to provide to the Matching Engine 250 the requests and original offer information that is required for the Matching Engine 250 to perform its tasks. The determination information is returned from the Matching Engine 250 after the Matching Engine 250 has determined whether the better offer is available.

The management program 280 and database 290 are provided to ease the processing of a plurality of facilitation requests from the User's computer 100, the Publisher Server 140 and/or other computers and Web servers, in that a plurality of users may attempt to use the functionality of the system 100 during any given period of time. The management program 280 and database 290 are able in this regard to process and track the various requests so that, for example, the request made by one user is not answered with the determination made for another user. Still, it should be evident that a real-time or near real-time system can additionally or alternately be used where requests are processed sequentially, and information that is passed through the Order Server 150 is stored only temporarily if at all before being re-sent as required to other components of the system. This may be preferable, for example, when a low volume of requests is expected, and/or a less expensive system is desired.

In this embodiment, the request information includes a request identifier, a request type, and the original offer information. Preferably, the request identifier is a unique identifier, assigned by the management program 280, that is used to distinguish the request from other requests as the requests are being processed. Preferably, the request type is an indication as to the type of direction that the Order Server 150 should give to the Matching Engine 250. In the following examples, the Order Server 150 directs the Matching Engine 250 to determine whether the better offer is available, and if so, accept the better offer on behalf of the user originating the request.

In this embodiment, the determination information returned from the Matching Engine 250 includes the request information (e.g., so that the Order Server 150 can match the incoming determination information to the request for which the determination was made), an indication as to whether the better offer is available, and, when the better offer is available, the better offer information and an indication that the better offer was accepted on behalf of the user originating the request. The indication as to whether the better offer is available can be inherent when the better offer information is provided as part of the determination information. The better offer information preferably includes the parameters of the better offer. In this embodiment, the better offer information includes the identity of the product being offered, the offer price, and the identity of the offeror.

The Order Server 150 further includes an interaction program 300 that interacts with the computers 100,110,120,130 and Publisher Server 140 and/or other computers and Web servers using HTTP, TCP/IP and other Internet communication protocols. The interaction includes receiving information from, and distributing information to, the computers and Web servers via the Internet 160. Depending on the particular interaction required, the interaction program 300 dynamically selects and/or constructs a plurality of Web pages for presentation to the computers and/or Web servers. The Web pages and/or components of the Web pages are stored as files on the hard drive 154 of the Order Server 150 and contain, to the extent required by the processes described herein, the request information and the determination information. Further, the interaction program 300 interacts with the management program 280 to coordinate the functions of the programs in response to the requests and determinations.

The programs 280, 300 can, as required, instruct one another, make requests of one another, and share information. This functionality and the functionality of each of the programs individually are directed by the CPU 151 of the Order Server 150. The information described herein in relation to the described functionality is stored as required on the hard drive 154 of the Order Server 150. Communications with the computers and Web servers are accomplished using the communication hardware of the Order Server 150. This functionality, storage and communication will be described below with regard to the operation of the system 50.

Examples of software that can be used to effect the functions of one or more of the offer management program 165, registration program 180, transaction program 200, transaction processing system 220, and presentation program 230 include online retail store software suites, online auction house software suites, an iCat™ e-Commerce™ software suite, a Miva™ Merchant™ software suite, and a PerlShop™ software suite. Examples of software that can be used to effect the database management functions of one of more of the offer management program 165, registration program 180, transaction program 200, transaction processing system 220, and presentation program 230 include Microsoft™ SQL Server™ and Oracle™ Database Servers™. Examples of software that can be used to effect the functions of one of more of the interaction programs 240,300 include Microsoft™ Internet Information Server™ and Apache™ Web Server™.

During operation of the system 50, the User operates the User's computer 100 to connect to the Publisher's Web site and communicate with the interaction program 240 that, in coordination with the presentation program 230, enables the EUREKA-1 (3.0-001) User to navigate the Publisher's Web site. Once at the Publisher's Web site, the User uses the browsing and/or searching tools available on the Web site to request a Web page describing a plurality of offers, including the First Offer and the Second Offer. In response to the request, the Publisher Server 140, through the functionality of the offer management program 165 and database 170, delivers the requested Web page to the User's computer 100, thus presenting the User with at least one offer. The particular offer in which the User is interested will be referred to herein as the “original offer”. In some examples discussed below, the User is interested in the First Offer. In other examples discussed below, the User is interested in the Second Offer.

As indicated above with regard to offers generally, the original offer has at least two parameters, and at least one of those parameters identifies the product. The other parameter is some value associated with the product. In this embodiment, as noted above, one parameter is the identity of the product (e.g., the Item the User desires to purchase), another parameter is the consideration that must be paid in exchange for the product (e.g., the price of the Item), and another parameter is the identity of the offeror (e.g., the particular vendor making the offer).

The Web page not only presents the offers, but also provides access to functionality described below. The functionality can be accessed in this embodiment through a hypertext link included as part of the Web page. To inform the User of the available functionality, the Web page displays a suitable indicator (e.g., a graphic button) adjacent the description of each offer. The indicator serves as a label for the hypertext link, indicating that if the indicator is selected, the functionality will be accessed and carried out with regard to the adjacent offer. The indicator can be selected in any suitable manner. Preferably, the selection is accomplished by way of a singular action by the User. Examples of selection actions include clicking a button (e.g., a button of an input device connected to the User's computer), generating a sound (e.g., speaking into a microphone connected the User's computer while running a voice recognition software program on the computer for recognizing the speech, and/or generating a sound, via speaking or mechanical means, that is specifically recognizable by the User's computer to indicate the selection), pressing a keyboard key (e.g., a key on a keyboard connected to the User's computer), selecting using a remote control (e.g., an electromagnetic wave based and/or sound based remote control system or device in communication with the User's computer), selecting using a pointing device (e.g., a mouse, trackball, digital pen, trackpad, and/or thumb pointer in communication with the User's computer), and selecting a Web page object (e.g., selecting a graphic object and/or text displayed on a Web page).

The indicator indicates that by selecting the indicator, the User commits to accepting a better offer when the better offer is available, the better offer being similar with regard to at least one parameter (e.g., the product), and more optimal with regard to at least one other parameter (e.g., the price), than the original offer and other available offers. In this embodiment, the indicator also indicates that by selecting the indicator, the User commits to accepting the original offer unless a better offer is available.

In the following examples, the User considers a lower price to be more optimal than a higher price. It should be understood, however, that the optimal nature of the better offer can vary depending on the particular desires of the User, the particular nature of the product, the particular parameters of the offers, and any other factor. In some embodiments, the optimal nature of the better offer can be established when the better offer is determined by the Matching Engine 250 to have “price improvement” over the original offer, as that term is defined and discussed in the '033 application, and/or according to the manner in which “price improvement” is established as described in the '033 application.

With regard to the functionality accessible through the hypertext link, when the link is activated, the User's computer 100 receives from the Publisher Server 140 information describing the original offer, and transmits the original offer information along with a request to the Order Server 150. The request indicates to the Order Server 150 the commitment the User has made by selecting the indicator. As described below, the Order Server 150 can therefore direct the Matching Engine 250 accordingly. In some embodiments, when the User selects the indicator, the User can be understood to be submitting the original offer to the Matching Engine 250 for processing in accordance with the User's request. In such a case, the original offer can be considered a “test order” as that term is defined and discussed in the '033 application. Accordingly, an end user submitting an original offer can be understood to be a “test trader”, as that term is defined and discussed in the '033 application.

The original offer information preferably includes the parameters of the original offer. In this embodiment, the original offer information includes the identity of the product being offered, the offer price, the identity of the User, and the identity of the vendor making the offer. It should be understood that, depending on the vendors, the persons or entities operating the Publisher Server 140, the persons or entities operating the Order Server 150, and the particular product being offered, less, more and/or different information can be included in the original offer information.

It should be further understood that additional and/or alternate systems and methods can be used to transmit the original offer information and/or the request to the Order Server 150, and that transmission routes other than or in addition to the transmission route described above can be used. In addition, the original offer information and/or the request may be encrypted and/or otherwise protected to prevent the User and/or unauthorized parties from viewing, intercepting, and modifying the request and/or the original offer information.

Further with regard to the functionality accessible through the hypertext link, once the Order Server 150 receives the original offer information and the request, the Order Server 150 transmits a corresponding request along with the original offer information to the Matching Engine 250 to initiate and facilitate a matching process. In response to the request and using the original offer information, the matching program 260 performs the matching process, in which the matching program 260 accesses the available offer information in the matching database 270, compares the available offer information with the original offer information to determine whether the better offer is available.

The request by the Order Server 150 instructs and authorizes the Matching Engine 250 to accept the better offer on behalf of the User if the better offer is available. In this embodiment, the request by the Order Server 150 also instructs and authorizes the Matching Engine 250 to accept the original offer on behalf of the User if the better offer is not available and the original offer is in the matching database 270. In other embodiments, the request by the Order Server 150 also instructs and authorizes the Matching Engine 250 to accept the original offer on behalf of the User if the better offer is not available, even if the original offer is not in the matching database 270 before the request is made (e.g., the request by the Order Server 150 can also instruct the Matching Engine 250 to include the original offer information in the matching database 270).

Once the matching program 260 has completed the determination and any actions taken in light of the determination, the Matching Engine 250 transmits to an interested party information related to the determination. In this embodiment, one of the interested parties is the Order Server 150, and the information related to the determination includes the result of the determination. It should be understood that in other embodiments, additional and/or alternate parties and/or computers can be interested parties, depending on the configuration and/or functionality of the particular embodiment. It should also be understood that the information related to the determination can include less, more and/or different information than merely the result of the determination.

Accordingly, after the matching program 260 has completed its determination, and if the matching program 260 determines that the better offer is available, the matching program 260 accepts the better offer on behalf of the User. Acceptance of an offer as discussed herein can include an “execution” of a “trade” as those terms are defined and discussed in the '033 application. In addition, the Matching Engine 250 thereafter transmits a response to the Order Server 150. The response includes the original offer information and information describing the better offer. The response also includes, inherently and/or additionally, an indication that the matching program 260 has accepted the better offer on behalf of the User.

For example, if the User has selected the indicator adjacent the First Offer, the First Offer information is the original offer information that is sent to the Order Server 150 and forwarded to the Matching Engine 250. If, after comparing the First Offer with the available offer information in the matching database 270 (which information includes the Second Offer information and the Third Offer information), the matching program 260 determines that the better offer is available as the Second Offer (i.e., the Second Price is lower than the Third Price and the First Price), the matching program 260 will accept the Second Offer on behalf of the User. Further, the Matching Engine 250 will transmit a response to the Order Server 150 that includes the original offer information (the First Offer information) and the better offer information (the Second Offer information). The response also indicates that the matching program 260 has accepted the Second Offer on behalf of the User.

Preferably, the better offer information includes the identity of the product that is the subject of the better offer, the better offer price, and the identity of the offeror. It should be understood that, depending on the vendors, the persons or entities operating the Publisher Server 140, the persons or entities operating the Order Server 150, and the particular product being offered, less, more and/or different information can be included in the better offer information. In the previous example, the better offer information is the Second Offer information, and therefore includes the identity of the Item, the Second Price, and the identity of the Second Vendor.

Upon receiving this response from the Matching Engine 250, the Order Server 150 transmits an indication to the User's computer 100 that the better offer has been accepted on behalf of the User. Preferably, this indication takes the form of a confirmation Web page, delivered to the User's computer 100, that includes the better offer information. Also preferably, the confirmation Web page includes the original offer information, if, for example, it is desirable that the User be reminded of the parameters of the original offer. Also preferably, the Order Server 150 transmits an indication to the Publisher Server 140 that the better offer has been accepted on behalf of the User. This may be desirable, in that the Publisher may not otherwise be aware that the better offer was available and accepted on behalf of the User.

Alternately, after the matching program 260 has completed its determination, and if the matching program 260 determines that the better offer is not available, and if the original offer information has previously been stored in the matching database 270 (e.g., in the case where the Second Offer is the original offer), the matching program 260 accepts the original offer on behalf of the User and transmits a response to the Order Server 150 indicating that the better offer is not available and that the original offer was accepted on behalf of the User.

For example, if the User has selected the indicator adjacent the Second Offer, the Second Offer information is the original offer information that is sent to the Order Server 150 and forwarded to the Matching Engine 250. If, after comparing the Second Offer with the available offer information in the matching database 270 (which information includes the Second Offer information and the Third Offer information), the matching program 260 determines that the better offer is not available (i.e., the Second Price is lower than the Third Price), the matching program 260 will accept the Second Offer on behalf of the User. Further, the Matching Engine 250 will transmit a response to the Order Server 150 that indicates that the matching program 260 has accepted the Second Offer on behalf of the User.

Upon receiving this response from the Matching Engine 250, the Order Server 150 forwards the indication to the User's computer 100 and/or the Publisher Server 140. This indication can take the form of a Web page that confirms the User's acceptance of the original offer and the completion of the transaction in accordance with the parameters of the original offer. The Web page may also include additional information that may be useful to the User, such as a reminder as to the parameters of the original offer, and any suggestions as to additional items that can be purchased by the User. The Web page can also include an assurance to the User that although an attempt was made to find the better offer, the better offer was not found.

Alternately, after the matching program 260 has completed its determination, and if the matching program 260 determines that the better offer is not available, and if the original offer information has not previously been stored in the matching database 270 (e.g., in the case where the First Offer is the original offer), the matching program 260 transmits a response to the Order Server 150 indicating the same.

For example, if the User has selected the indicator adjacent the First Offer, the First Offer information is the original offer information that is sent to the Order Server 150 and forwarded to the Matching Engine 250. If, after comparing the First Offer with the available offer information in the matching database 270 (which information includes the Second Offer information and the Third Offer information), the matching program 260 determines that the better offer is not available (i.e., the First Price is lower than the Second Price and the Third Price), the matching program 260 will transmit a response to the Order Server 150 that the better offer is not available.

Upon receiving this response from the Matching Engine 250, the Order Server 150 transmits an indication to the Publisher Server 140 that the better offer is not available. Preferably, this indication takes the form of an HTTP request to the Publisher Server 140.

Thereafter, the Publisher Server 140 determines what action will be taken, and transmits a response to the Order Server 150 indicating the action. Preferably, this response takes the form of a Web page that identifies the action and/or includes additional useful information. After receiving the response from the Publisher Server 140, the Order Server 150 forwards the response to the User's computer 100. Preferably, the Order Server 150 adds an indication to the response, if not included already, that indicates that an attempt was made to find the better offer, and that the better offer was not found. When the response takes the form of a Web page, for example, the Order Server 150 may add its own HTML code to the Web page that adds text or graphics to the Web page indicating the same, without compromising the content of the response from the Publisher Server 140.

Actions that may be taken by the Publisher Server 140 can include the acceptance of the original offer on behalf of the User in accordance with the above-described commitment of the User made by selecting the indicator. In this event, the Publisher Server 140 uses the transaction program 200, database 210, and processing system 220 to complete a transaction with the User in accordance with the parameters of the original offer. Accordingly, the response of the Publisher Server 140 to the Order Server 150 can take the form of a Web page that confirms the User's acceptance of the original offer and the completion of the transaction in accordance with the parameters of the original offer. The Web page may also include additional information that may be useful to the User, such as a reminder as to the parameters of the original offer, and any suggestions as to additional items that can be purchased by the User. The Order Server 150, or the Publisher Server 140, may include as part of the Web page an assurance to the User that although an attempt was made to find the better offer, the better offer was not found.

Actions that may be directed by the Publisher Server 140 can alternatively or additionally include presenting one or more alternate offers.

In either of the alternate cases discussed above, the indication from the Order Server 150 to the Publisher Server 140 that the better offer is not available can alternately take the form of a re-direction request, such as a “browser redirect”request of a type known in the art. In this event, the request can be sent via the User's computer 100 to the Publisher Server 140, to cause the Publisher Server 140 to deliver a Web page to the User's computer 100 that identifies what action will be taken and includes additional useful information. The actions can include, for example, the actions discussed above and/or other actions.

While the invention has been described as primarily directed to situations in which vendors present offers to sell products and users accept the offers, it should be understood that the invention can additionally or alternately be used for situations where parties present offers to buy products at various prices and users accept the offers.

Further, while the invention has been described for use in connection with an Internet using Internet communication protocols, it should be understood that the invention can be used in connection with any type of network of computers, using any suitable communication protocol. For example, wired, wireless, satellite, cellular, PCS, digital subscriber line, cable line, radio transmitters, regular mail, disk transfer, voice, and the like, are all suitable for use with the invention. As another example, parties (e.g., vendors and/or users) may transfer information (e.g., offer information and/or user information) via other methods such as, for example copying the information to a storage medium (e.g., a magnetic disk) and mailing the storage medium to another party, and printing the information on paper or another material and mailing the material to another party. In the latter case, additional system components can aid in the transfer such as, for example, personnel that will input the printed information into the appropriate database. As another example, computer networks and communication protocols common in particular industries can also be used, such as, for example, the networks and communication protocols commonly used in financial or collectibles trading systems. As another example, in some embodiments nodes of the network may enjoy a dedicated or substantially dedicated communication channel. For example, certain dedicated communication channels that can be used could provide computers with direct access to a server's database, so that information can be transferred therebetween more quickly and easily than through other methods.

Further, it should be understood that the communication and information transmission in any particular embodiment can include several different types of communication systems and methods, with each communication and/or information transfer being achieved in a different manner than at least one another transfer. For example, while certain computers in a particular embodiment may communicate with and provide information to servers using a dial-up modem, other computers may communicate with and provide information to servers using a dedicated communication channel.

Further, the communications and/or information transferred as discussed herein may be encrypted and/or otherwise protected during transmission to prevent the User and/or unauthorized parties from viewing, intercepting, and modifying the communications and/or information.

Finally, although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for facilitating a transaction, comprising:
receiving information describing an offer presented to a user; and
receiving an indication that the user desires to accept the offer unless a better offer is available, and accept the better offer when the better offer is available, the better offer being similar with regard to at least one parameter, and more optimal with regard to at least one other parameter, than the offer and other available offers.

2. The method of claim 1, further comprising:
providing the offer information for delivery to a system having access to information describing the other available offers, being adapted to compare the offer information with the available offer information to determine whether the better offer is available, being adapted to provide information related to the determination, and being adapted to accept the better offer on behalf of the user when the better offer is available; and
receiving the determination information and providing the determination information for delivery to an interested party; wherein
when the better offer is not available, the determination information comprises an indication that the better offer is not available; and wherein
when the better offer is available, the determination information comprises at least one of an indication that the better offer is available, a description of the better offer, and an indication that the better offer has been accepted by the system.

3. The method of claim 2, wherein:
the system is further adapted to accept the offer on behalf of the user unless the better offer is available; and
when the better offer is not available, the determination information further comprises an indication that the offer has been accepted by the system.

4. The method of claim 1, wherein the one parameter is a product identity and the other parameter is a consideration amount to be paid in exchange for the product.

5. The method of claim 1, wherein the interested party is selected from the group consisting of the user, an offeror of the offer, and an offeror of the better offer.

6. The method of claim 1, wherein receiving the offer information and receiving the indication are as a result of a singular action by the user.

7. The method of claim 6, wherein the action is selected from the group consisting of clicking a button, generating a sound, pressing a keyboard key, selecting using a remote control, selecting using a pointing device, and selecting a Web page object.

8. A method for facilitating a transaction, comprising:
publishing information describing an offer for presentation to a user; and
providing an option for the user to accept the offer unless the better offer is available, and to accept the better offer when the better offer is available, the better offer being similar with regard to at least one parameter, and more optimal with regard to at least one other parameter, than the offer and other available offers.

9. The method of claim 8, further comprising:
receiving an indication that the user desires to exercise the option; and
providing the offer information for delivery to a system having access to information describing the other available offers, being adapted to compare the offer information with the available offer information to determine whether the better offer is available, being adapted to provide information related to the determination, and being adapted to accept the better offer on behalf of the user when the better offer is available.

10. The method of claim 9, wherein the offer information is provided to the system through an intermediary.

11. The method of claim 9, wherein the system is further adapted to accept the offer on behalf of the user unless the better offer is available.

12. The method of claim 9, further comprising receiving the determination information, and wherein:
when the better offer is available, the determination information comprises an indication that the better offer is available; and
when the better offer is not available, the determination information comprises an indication that the better offer is not available.

13. The method of claim 12, wherein the determination information is received through an intermediary.

14. The method of claim 12, further comprising, when the better offer is not available, accepting the offer on behalf of the user.

15. The method of claim 14, further comprising, when the better offer is not available, providing for delivery to the user an indication that the better offer is not available.

16. The method of claim 8, wherein publishing the offer information for presentation to the user comprises publishing information describing a plurality of offers, the offer being one of said plurality of offers.

17. The method of claim 8, wherein the offer is offered using a Web page.

18. The method of claim 8, wherein the indication that the user desires to exercise the option is provided by the user performing an action selected from the group consisting of clicking a button, generating a sound, pressing a keyboard key, selecting using a remote control, selecting using a pointing device, and selecting a Web page object.

19. The method of claim 8, wherein the option is made available via a Web page and can be exercised by selecting a portion of the Web page.

20. The method of claim 19, wherein the portion of the Web page displays a graphic button.

21. A system including at least one microprocessor operating under the control of at least one software program capable of causing the system to execute actions in facilitating a transaction, the actions comprising:
receiving information describing an offer presented to a user; and
receiving an indication that the user desires to accept the offer unless a better offer is available, and accept the better offer when the better offer is available, the better offer being similar with regard to at least one parameter, and more optimal with regard to at least one other parameter, than the offer and other available offers.

22. The system of claim 21, wherein the actions further comprise:
providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available; and
receiving the determination information and providing the determination information for delivery to an interested party; wherein
when the better offer is not available, the determination information comprises an indication that the better offer is not available; and wherein
when the better offer is available, the determination information comprises at least one of an indication that the better offer is available, a description of the better offer, and an indication that the better offer has been accepted by the determining system.

23. The method of claim 22, wherein:
the determining system is further adapted to accept the offer on behalf of the user unless the better offer is available; and
when the better offer is not available, the determination information further comprises an indication that the offer has been accepted by the determining system.

24. The method of claim 21, wherein the one parameter is a product identity and the other parameter is a consideration amount to be paid in exchange for the product.

25. The method of claim 21, wherein the interested party is selected from the group consisting of the user, an offeror of the offer, and an offeror of the better offer.

26. The method of claim 21, wherein receiving the offer information and receiving the indication are as a result of a singular action by the user.

27. The method of claim 26, wherein the action is selected from the group consisting of clicking a button, generating a sound, pressing a keyboard key, selecting using a remote control, selecting using a pointing device, and selecting a Web page object.

28. A system including at least one microprocessor operating under the control of at least one software program capable of causing the system to execute actions in facilitating a transaction, the actions comprising:
publishing information describing an offer for presentation to a user; and
providing an option for the user to accept the offer unless the better offer is available, and accept the better offer when the better offer is available, the better offer being similar with regard to at least one parameter, and more optimal with regard to at least one other parameter, than the offer and other available offers.

29. The system of claim 27, wherein the actions further comprise:
receiving an indication that the user desires to exercise the option; and
providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available.

30. The method of claim 29, wherein the offer information is provided to the determining through an intermediary.

31. The method of claim 29, wherein the determining system is further adapted to accept the offer on behalf of the user unless the better offer is available.

32. The method of claim 29, further comprising receiving the determination information, and wherein:
when the better offer is available, the determination information comprises an indication that the better offer is available; and
when the better offer is not available, the determination information comprises an indication that the better offer is not available.

33. The method of claim 32, wherein the determination information is received through an intermediary.

34. The method of claim 32, further comprising, when the better offer is not available, accepting the offer on behalf of the user.

35. The method of claim 34, further comprising, when the better offer is not available, providing for delivery to the user an indication that the better offer is not available.

36. The method of claim 28, wherein publishing the offer information for presentation to a user comprises publishing information describing a plurality of offers, the offer being one of said plurality of offers.

37. The method of claim 28, wherein the offer is offered using a Web page.

38. The method of claim 28, wherein the indication that the user desires to exercise the option is provided by the user performing an action selected from the group consisting of clicking a button, generating a sound, pressing a keyboard key, selecting using a remote control, selecting using a pointing device, and selecting a Web page object.

39. The method of claim 28, wherein the option is made available via a Web page and can be exercised by selecting a portion of the Web page.

40. The method of claim 39, wherein the portion of the Web page displays a graphic button.

41. A system capable of facilitating a transaction, comprising:
means for receiving information describing an offer presented to a user; and
means for receiving an indication that the user desires to accept the offer unless a better offer is available, and accept the better offer when the better offer is available, the better offer being similar with regard to at least one parameter, and more optimal with regard to at least one other parameter, than the offer and other available offers.

42. The system of claim 41, further comprising:
means for providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available; and
means for receiving the determination information and providing the determination information for delivery to an interested party; wherein
when the better offer is not available, the determination information comprises an indication that the better offer is not available; and wherein
when the better offer is available, the determination information comprises at least one of an indication that the better offer is available, a description of the better offer, and an indication that the better offer has been accepted by the determining system.

43. The method of claim 42, wherein:
the determining system is further adapted to accept the offer on behalf of the user unless the better offer is available; and
when the better offer is not available, the determination information further comprises an indication that the offer has been accepted by the determining system.

44. The method of claim 41, wherein the one parameter is a product identity and the other parameter is a consideration amount to be paid in exchange for the product.

45. The method of claim 41, wherein the interested party is selected from the group consisting of the user, an offeror of the offer, and an offeror of the better offer.

46. The method of claim 41, wherein receiving the offer information and receiving the indication are as a result of a singular action by the user.

47. The method of claim 46, wherein the action is selected from the group consisting of clicking a button, generating a sound, pressing a keyboard key, selecting using a remote control, selecting using a pointing device, and selecting a Web page object.

48. A system capable of facilitating a transaction, comprising:
means for publishing information describing an offer for presentation to a user; and
means for providing an option for the user to accept the offer on behalf of the user unless the better offer is available, and to accept the better offer on behalf of the user when the better offer is available, the better offer being similar with regard to at least one parameter, and more optimal with regard to at least one other parameter, than the offer and other available offers.

49. The system of claim 48, further comprising:
means for receiving an indication that the user desires to exercise the option; and
means for providing the offer information for delivery to a determining system having access to information describing the other available offers, being adapted to compare the offer information with the available offer information to determine whether the better offer is available, being adapted to provide information related to the determination, and being adapted to accept the better offer on behalf of the user when the better offer is available.

50. The method of claim 49, wherein the offer information is provided to the determining system through an intermediary.

51. The method of claim 49, wherein the determining system is further adapted to accept the offer on behalf of the user unless the better offer is available.

52. The method of claim 49, further comprising receiving the determination information, and wherein:
when the better offer is available, the determination information comprises an indication that the better offer is available; and
when the better offer is not available, the determination information comprises an indication that the better offer is not available.

53. The method of claim 52, wherein the determination information is received through an intermediary.

54. The method of claim 52, further comprising, when the better offer is not available, accepting the offer on behalf of the user.

55. The method of claim 54, further comprising, when the better offer is not available, providing for delivery to the user an indication that the better offer is not available.

56. The method of claim 48, wherein publishing the offer information for presentation to a user comprises publishing information describing a plurality of offers, the offer being one of said plurality of offers.

57. The method of claim 48, wherein the offer is offered using a Web page.

58. The method of claim 48, wherein the indication that the user desires to exercise the option is provided by the user performing an action selected from the group consisting of clicking a button, generating a sound, pressing a keyboard key, selecting using a remote control, selecting using a pointing device, and selecting a Web page object.

59. The method of claim 48, wherein the option is made available via a Web page and can be exercised by selecting a portion of the Web page.

60. The method of claim 59, wherein the portion of the Web page displays a graphic button.
